(19) United States
(12) Patent Application Publication
(10) Pub. No.: US 2012/0288639 A1
(43) Pub. Date: Nov. 15, 2012

(54) COMBINED HEATING FOR SOLDERING AN ARMOR CLADDING ONTO A TIP BY MEANS OF INDUCTION AND LASER

(75) Inventor: Herbert Hanrieder, Hohenkammer (DE)

(73) Assignee: MTU AERO ENGINES GMBH, Munchen (DE)

(21) Appl. No.: 13/468,429

(22) Filed: May 10, 2012

(30) Foreign Application Priority Data
May 13, 2011 (DE) 10 2011 101 576.4

(51) Int. Cl. H05B 6/10; B05D 3/02; B05D 3/06; B05D 7/00

(52) U.S. Cl. 427/543; 219/601

(57) ABSTRACT

The present invention relates to a method for coating a component (1) of a gas turbine or an aircraft engine, in particular for producing a blade-tip armor cladding on a blade of a gas turbine or aircraft engine, in which a coating material is applied to the component with a solder and the component is heated inductively, with at least the solder of the coating material being heated by means of a laser (4) in such a way that solder connection between the component and the coating material is achieved, as well as a corresponding device for carrying out the method.

### BACKGROUND OF THE INVENTION

1. Field of the Invention

The present invention relates to a method for coating a component of a gas turbine or aircraft engine, in particular for producing a blade-tip armor cladding on a blade of a gas turbine or an aircraft engine, in which a coating material is applied to the component with a solder and the component is heated inductively, as well as a corresponding device.

2. Prior Art

It is known from the prior art to furnish the blade tips of gas turbines or aircraft engines, that is, generally turbomachines, with an armor cladding to protect the rotating blades of a gas turbine or aircraft engine from wear. In particular, such an armor cladding in the region of the blade tips serves to protect the blades, which slide against a casing so as to create a structure that is as tight as possible, and to provide for the abraded material in the casing.

Known from DE 10 2009 008 887 A1, DE 10 2007 010 256 A1, DE 10 2009 007 666 A1, DE 10 2008 003 100 A1, and U.S. Pat. No. 4,818,833 are various methods for armor cladding the tips of blades of a gas turbine or aircraft engine.

Thus, for example, DE 10 2007 010 256 A1 describes the inductive heating of a blade tip by use of an induction amplifier, while, in U.S. Pat. No. 4,818,833, the limited heating of the blade tip is to be accomplished by special formation of a corresponding receiving space and deliberate insertion and retraction of the blade tips in the receiving space.

However, in the proposed solutions, there is still the problem that the heating of the blade tip also entails heating of the turbine blade, which can lead to local overheating of the blade material. As a result, a property change can occur in the material of the base body of the blade and thus a degradation in the properties of the blade.

### SUMMARY OF THE INVENTION

### Problem of the Invention

Therefore, the problem of the present invention to provide a method for coating a component of a gas turbine or an aircraft engine, in particular a method for producing a blade-tip armor cladding on a blade of a gas turbine or an aircraft engine, as well as a corresponding device for carrying out such a method, in which the temperature load on the base material of the blade is minimized, with it being possible, at the same time, to construct the device and carry out the method in a simple manner and to ensure a qualitatively high-grade coating of the component.

### Technical Solution

This problem is solved by a method having the features of claim 1 as well as a device having the features of claim 11. Advantageous embodiments are the subject of the dependent claims.

The invention is characterized in that a combination of inductive heating of the component and targeted heating of a local region of the component to be coated or the coating material is undertaken. It is ensured through these measures that the coating material is bonded securely and reliably with the base material of the component and, at the same time, overheating of the base material is prevented.

The local heating is effected by laser-light irradiation using a laser, so that a targeted warming in terms of place and scope of heating is possible. Beyond this, the use of a laser allows a simple sweeping (scanning) of a surface of a component to be coated.

In accordance with the invention, the material to be coated is applied to the component with a solder, so that, by means of the solder, a firm bonding of the coating material or its elements with the component is achieved. For example, the hard particles of an armor cladding are embedded in the solder, which, through the soldering, undergoes firm bonding with the base material of the blade.

The intensity of the light irradiation in terms of light intensity and intensity over time can be chosen such that exactly the temperature required for soldering is produced in the region of the coating material applied to the component. In this process, it is possible to use both fusion solders and diffusion solders, with fusion solder being preferred since the process can be accomplished faster.

The component temperature produced by induction in the region in which the coating is to be applied can appropriately lie below the required soldering temperature, in particular up to 500° C., preferably up to 300° C. or 200° C., below the appropriate soldering temperature. This is dependent on the chosen material of the component, the coating, and the solder.

The induction heating can commence already some time prior to the start of laser heating and can be continued over the period of time in which the laser heating takes place. Alternatively, it is also possible to start the laser heating simultaneously with the induction heating or to discontinue the induction heating in part or in whole during the laser heating.

The coating material and/or the solder can be applied already prior to the induction heating, after the induction heating and prior to the laser heating, or even during the induction heating.

The coating material can be applied, in particular, in the form of a molded part, which can additionally include the solder as well. A corresponding molded part can be formed as a strip or film and can comprise at least a binder and an element of the coating to be produced, such as, for example, the hard particles for the armor cladding. The solder can be added in appropriate powder form to the molded part, so that, for example, a so-called soldering tape made from a matrix composed of binder and soldering powder with embedded hard particles can be formed for creating a corresponding armor cladding.

The solder is chosen depending on the coating material and the base material of the component to be coated, with it being possible to employ particularly a titanium-based solder or a nickel-based solder, that is, a solder containing nickel or titanium as the principal constituent, for the intended purpose of the application. In general, a eutectic solder containing at least one base material of the component to be coated can be is employed, to which an appropriate element for lowering the fusion temperature is added to lower the melting temperature.

The solder can also have an MCrAlY matrix or an MCrAlXZ matrix, with M being iron, cobalt, nickel, nickel-cobalt, or cobalt-nickel and it being possible for X to be formed by silicon, tantalum, vanadium, niobium, platinum, or palladium and Z by yttrium, titanium, hafnium, zirconium, or ytterbium.

The binder can be a plastic, in particular a thermoplastic.

The coating material can have any suitable composition. Particularly for creating an armor cladding, it may contain hard particles made of ceramic materials, nitrides, carbides, borides, oxides, in particular boron nitride, cubic boron nitride, titanium carbide, tungsten carbide, chromium carbide, aluminum oxide, and/or zirconium oxide and/or combinations thereof.

Depending on the composition of the solder, the coating material and the binder, different soldering temperatures in the range of 800 to 1300° C., preferably 1000 to 1200° C., can be employed, it being possible to heat the component to temperatures in the range of 600 to 900° C. by way of the induction heating.

The device according to the invention for carrying out a corresponding method thus comprises, besides the induction device for heating the component to be coated, a laser that can irradiate and heat at least a partial region of the component to be coated. Accordingly, it is possible to employ lasers of different design and functional principles, which, can achieve an appropriate heating in conjunction with the component to be coated, the solder used, and the coating material.

The device can have an appropriate component receiver, in which the component to be coated can be arranged such that simultaneously an inductive heating and a heating by laser irradiation are possible in an appropriate manner. In particular, for the coating of blades of a gas turbine or an aircraft engine, the component receptacle can be arranged so that the blade tip is oriented in the direction of the laser so as to heat a solder placed there with a coating material, while induction loops can be created laterally on the blade surface, preferably parallel to the main surfaces, that is, the surfaces having the largest dimensions.

In particular, the present method enables both the coating of individual blades of a gas turbine or an aircraft engine and also the coating of component combinations, such as, for example, so-called blisks (combination of blade and disk (blisk) thus, blade and disk, as well as of other components to be carried out.

### BRIEF DESCRIPTION OF THE DRAWINGS

The appended figures show purely schematically:

FIG. 1 is a side view of a device according to the invention for implementing the method according to the invention; and

FIG. 2 is a plan view onto the device of FIG. 1 through the line A-A of FIG. 1.

### DETAILED DESCRIPTION OF THE INVENTION

Further advantages, characteristics, and features of the present invention will be clarified in the following detailed description of an embodiment example on the basis of the appended drawings. However, the invention is not limited to this embodiment example, but rather the scope of protection is governed by the appended claims.

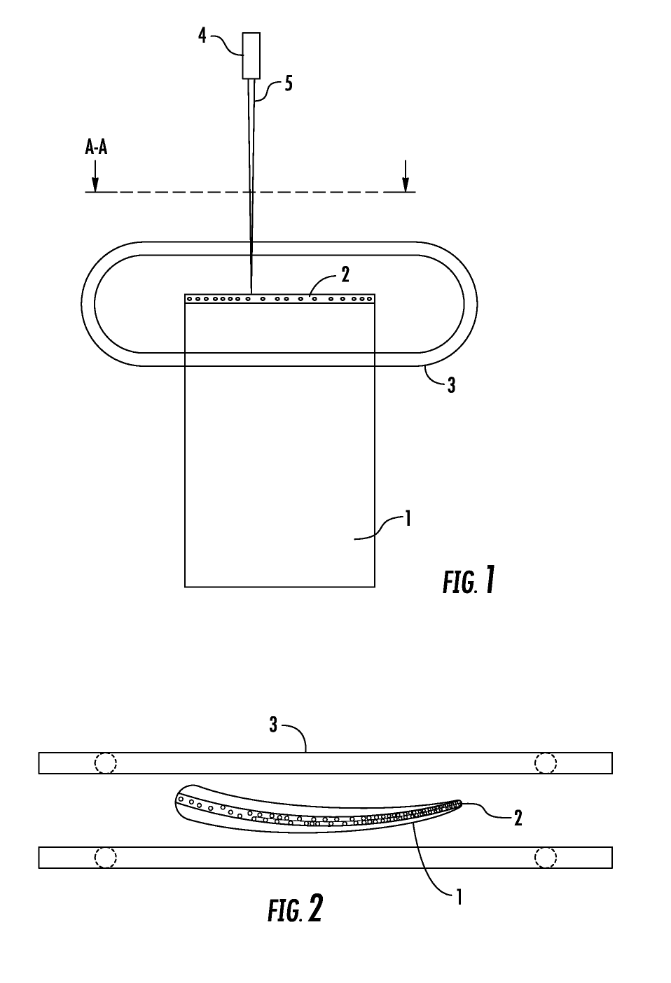

FIG. 1 shows a purely schematic illustration of a blade 1 of a gas turbine or an aircraft engine, which is provided with a tip armor cladding. Accordingly, a so-called tape 2, which contains the hard particles for creating the armor cladding, is applied to the tip of blade 1.

Tape 2 can be formed, for example, as a flexible strip or as a flexible film, with the hard particles being embedded in a matrix comprised of binder and soldering powder. When tape 2 is heated, the binder, for example, a thermoplastic, is combusted or vaporizes in the gaseous state, while the soldering powder fuses and bonds the hard particles embedded in tape 2 with the base material of blade 1.

For this purpose, the device shown in FIG. 1 comprises an induction device 3, which is represented by an induction coil 3, and a laser 4, which can produce a laser beam 5 that can be directed onto the tip of blade 1.

By way of the induction device, which is operated, for example, with high-frequency alternating current with frequencies in the range between 50 and 700 kHz, preferably 100 to 600 kHz, alternating magnetic fields are produced, which, in turn, induce currents in blade 1 that lead to a heating of blade 1. The heat produced in this way in blade 1 brings about a preheating, which, however, is adjusted in such a way, that the target temperature is below the soldering temperature that is required for soldering tape 2 onto the blade 1.

The required soldering temperature in the region of the blade tip for soldering tape 2 onto blade 1 is produced by laser 4 or laser beam 5, which can be swept over the region of the blade tip, so that the soldering temperature is attained locally for a brief time in the region of tape 2, so that tape 2 is soldered onto blade 1. In this process, the binder is combusted or expelled and the soldering powder is fused, so that the hard particles contained therein, which are embedded in the solder, are bonded to the blade tip of blade 1.

In the plan view of FIG. 2, the arrangement of tape 2, in particular, on the blade tip of blade 1, and the lateral arrangement of induction loops 3 next to the blade surface are more clearly evident. As is shown in FIG. 2, the coating material in the form of the tape 2 is disposed as a narrow strip on the blade tip of blade 1, it being possible to prefasten the strip, for example, by adhesive attachment, spot welding, or in a similar manner. The induction loops 3 are arranged parallel to the main surfaces of blade 1, that is, the side walls of the blade that form the pressure and suction side of the gas-turbine blades, in order to enable, in particular, an effective heating of the blade 1 in the region of the blade tip. Owing to the use of a laser for local and targeted attainment of the soldering temperature at the blade tip, the temperature that has to be produced by the induction device can be chosen to be so low that the material of blade 1 is not altered and, in particular, is not adversely affected. A critical supply of heat thus occurs only in the region of the blade tip up to the region of the diffusion zone of the solder connection.

The method according to the invention has the further advantage that, by means of the laser 4, the locally delimited fusion can be carried out exactly for a wide variety of component geometries, because the laser beam 5 can be appropriately well positioned in location. Accordingly, a simple automation of the method can be carried out.

Although the present invention has been described in detail on the basis of the embodiment example, it is obvious to the person skilled in the art that the invention is not limited to this embodiment example, but rather modifications are possible such that individual features can be omitted or other types of combinations of features can be undertaken, without any departure from the scope of protection of the appended claims. The disclosure of the present invention encompasses, in particular, all combinations of all of the individual features.

What is claimed is:

1. A method for coating a component (1) of a gas turbine or aircraft engine for producing a blade-tip armor cladding on a blade of a gas turbine or an aircraft engine, comprising the steps of:
applying a coating material to the component with a solder;
heating the component inductively;
wherein at least the solder of the coating material is heated by means of a laser (4) in such a way that a solder connection between the component and the coating material is achieved.

2. The method according to claim 1, wherein by means of the laser (4), a temperature that enables fusion soldering and/or diffusion soldering is produced in the region of the coating material applied to component (1).

3. The method according to claim 1, wherein the temperature of component (1) produced by induction lies below the temperature required for fusion soldering and/or diffusion soldering, in particular up to 500° C., preferably up to 350° C., below the temperature required for fusion soldering and/or diffusion soldering of the solder.

4. The method according to claim 1, wherein the coating material and/or the solder is applied prior to induction heating, after induction heating, or during induction heating.

5. The method according to claim 1, wherein the induction heating occurs prior to and/or during the laser heating.

6. The method according to claim 1, wherein the coating material is applied in the form of a molded part (2), which is formed as a strip or film and comprises at least a binder and elements of the coating to be produced.

7. The method according to claim 6, wherein the molded part additionally comprises the solder in powder form.

8. The method according to claim 1, wherein the solder is selected from group consisting of a titanium-based solder, a nickel-based solder, a eutectic solder containing at least one base material of the component to be coated, a solder with an MCrAlY matrix or MCrAlXZ matrix with M=Fe, Co, Ni, NiCo, and CoNi, X=Si, Ta, V, Nb, Pt, Pd, and Z=Y, Ti, Hf, Zr, Yb.

9. The method according to claim 6, wherein the binder is a plastic.

10. The method of claim 9, wherein the plastic is a thermoplastic.

11. The method according to claim 1, wherein the coating material comprises hard particles made of ceramic materials, nitrides, carbides, borides, and oxides.

12. The method according to claim 11, wherein the coating material comprises boron nitride, cubic boron nitride, titanium carbide, tungsten carbide, chromium carbide, aluminum oxide, and/or zirconium oxide and/or combinations thereof.

13. A device for coating a component of a gas turbine or an aircraft engine for producing a blade-tip armor cladding on a blade of a gas turbine or an aircraft engine, comprising:
an induction device (3) for heating the component to be coated with a coating material with a solder;
a laser (4), which is arranged so that, during the inductive heating of component (1), the laser beam can irradiate and heat at least a partial region of the component.
wherein at least the solder of the coating material is heated by the laser (4) in such a way that a solder connection between the component and the coating material is achieved.

14. The device according to claim 13, further comprising:
a component receptacle, which is aligned so that a blade to be coated of a gas turbine or an aircraft engine is oriented with the blade tip in the direction of the laser, while at least one induction coil is arranged laterally to the blade surface.

15. The device according to claim 14, wherein the at least one induction is two induction coils.
